(19) United States
(12) Patent Application Publication
(10) Pub. No.: US 2026/0242016 A1
(43) Pub. Date: Aug. 20, 2026

(54) DRIVE WHEEL ASSEMBLY AND TRACK SYSTEM HAVING SAME

(71) Applicant: SOUCY INTERNATIONAL INC., Drummondville (CA)

(72) Inventors: Gabriel LANDRY, Saint-Mathieu-de-Laprairie (CA); Styve ALLIE, Drummondville (CA)

(21) Appl. No.: 19/541,924

(22) Filed: Feb. 17, 2026

Related U.S. Application Data
(60) Provisional application No. 63/759,652, filed on Feb. 18, 2025.

(51) Int. Cl. B62D 55/125; B62D 55/14

(52) U.S. Cl. CPC B62D 55/125; B62D 55/14

(57) ABSTRACT

A drive wheel assembly, which is for a track system, includes a flange, a drive wheel, an extension and a plurality of fasteners. The flange is configured to be drivingly connected to a hub of a vehicle, and defines a plurality of flange apertures. The drive wheel is engaged to the flange, and defines a plurality of drive wheel apertures. The extension is engaged to the drive wheel, and includes a connecting portion and a shaft portion. The connecting portion defines a plurality of extension apertures. The shaft portion extends axially from the connecting portion, and is configured to be supported by a frame of the track system. The plurality of fasteners is for fastening the flange, the drive wheel and the extension to one another. Each fastener extends through a respective flange aperture, a respective drive wheel aperture, and a respective extension aperture.

### CROSS-REFERENCE TO RELATED APPLICATION

The present application claims priority to United States Provisional Patent Application No. 63/759,652, filed February 18, 2025, entitled “Drive Wheel Assembly and Track System Having Same”, which is incorporated by reference herein in its entirety.

### TECHNICAL FIELD

The present application generally relates to drive wheel assemblies and track systems comprising such drive wheel assemblies.

### BACKGROUND

Track systems are provided with drive wheel assemblies. These drive wheel assemblies can be large and expensive to manufacture. Additionally, these drive wheel assemblies can be tedious to connect to vehicle hubs or to their respective frame members.

### SUMMARY

It is an object of the present technology to ameliorate at least some of the inconveniences present in the prior art.

According to an aspect of the present technology, there is provided a drive wheel assembly for a track system. The drive wheel assembly includes a flange, a drive wheel, an extension and a plurality of fasteners. The flange is configured to be drivingly connected to a hub of a vehicle, and defines a plurality of flange apertures. The drive wheel is engaged to the flange, and the drive wheel defines a plurality of drive wheel apertures. The extension is engaged to the drive wheel, and includes a connecting portion and a shaft portion. The connecting portion defines a plurality of extension apertures. The shaft portion extends axially from the connecting portion, and is configured to be supported by a frame of the track system. The plurality of fasteners are for fastening the flange, the drive wheel and the extension to one another. Each one of the plurality of fasteners extends through a flange aperture of the plurality of flange apertures, a drive wheel aperture of the plurality of drive wheel apertures, and an extension aperture of the plurality of extension apertures.

In some embodiments, the drive wheel is sandwiched between the flange and the extension.

In some embodiments, the connecting portion defines a recess, the drive wheel defines an aperture, and part of the flange is received through the recess and through the aperture.

In some embodiments, the drive wheel has a plurality of teeth, the plurality of teeth extending in an axial direction.

According to another aspect of the present technology, there is provided a track system comprising a frame, at least one support wheel assembly rotationally connected to the frame, the drive wheel assembly according to the above aspect or according to the above aspect and one or more of the above embodiments, and an endless track. The drive wheel assembly is rotationally connected to the frame. The endless track surrounds the frame, the at least one support wheel assembly and the drive wheel assembly.

In some embodiments, the drive wheel assembly is configured to be disposed laterally between the frame and the vehicle.

In some embodiments, the frame defines an aperture, the shaft portion of the extension is received in the aperture, and a bearing is disposed between the shaft portion and the frame.

In some embodiments, the frame further includes a cap for enclosing one side of the aperture.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

For purposes of the present application, terms related to spatial orientation when referring to a track system and components in relation thereto, such as “vertical”, “horizontal”, “forwardly”, “rearwardly”, “left”, “right”, “above” and “below”, are as they would be understood by a driver of a vehicle to which the track system is connected, in which the driver is sitting on the vehicle in an upright driving position, with the vehicle steered straight-ahead and being at rest on flat, level ground.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description, which is to be used in conjunction with the accompanying drawings, where:

FIG. 1 is a perspective view taken from the top, rear, left side of a track system according to an embodiment of the present technology;

FIG. 2 is a perspective view taken from the top, rear, right side of the track system of FIG. 1;

FIG. 3 is a cross-sectional perspective view of the track system of FIG. 1, the cross-section being taken along a lateral central plane of the track system; and

FIG. 4 is an exploded perspective view of a drive wheel assembly of the track system of FIG. 1.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein are for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

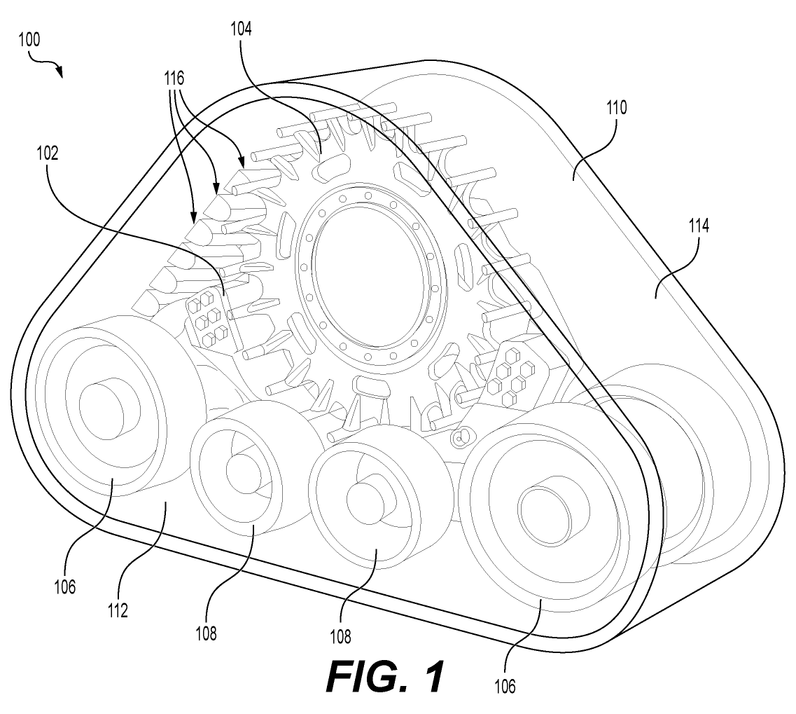

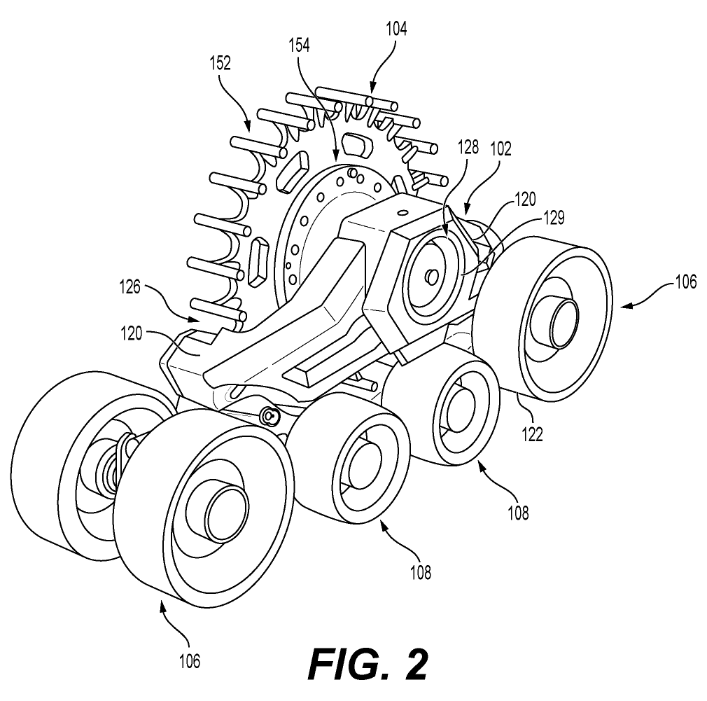

Referring to FIGS. 1 to 3, a track system 100 according to one embodiment of the present technology is shown. The track system 100 includes a frame 102, a drive wheel assembly 104, front and rear idler wheel assemblies 106, support wheel assemblies 108 and an endless track 110.

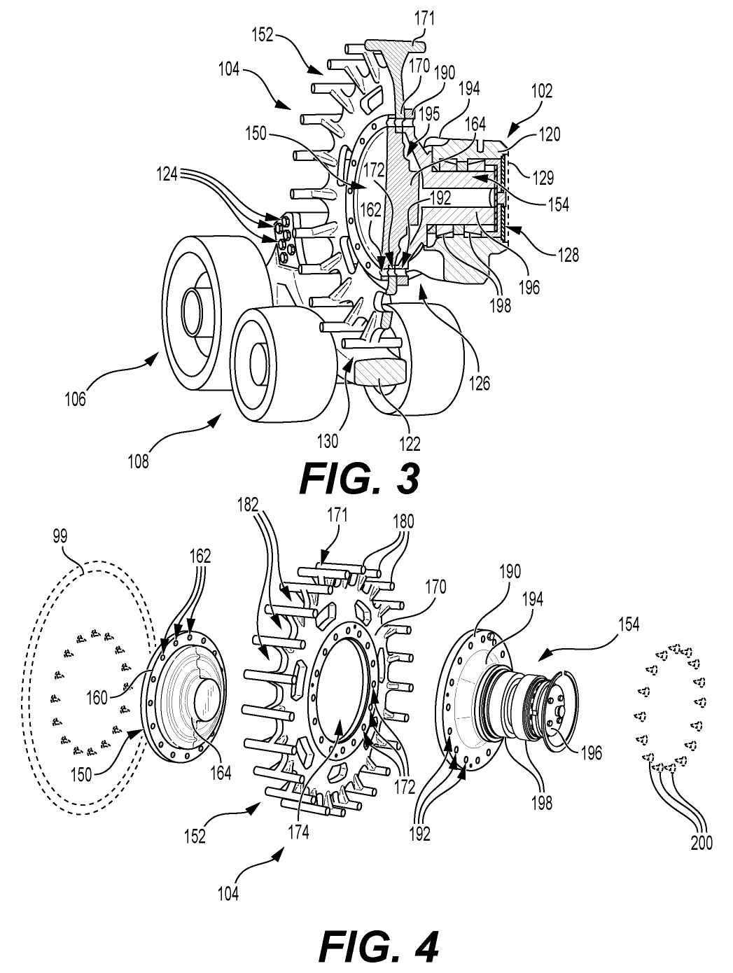

The frame 102 includes an upper frame member 120 and a lower frame member 122 fastened to the upper frame member 120 via fasteners 124 (shown in FIG. 3). It is contemplated that in some embodiments, the frame 102 could be monolithic. It is also contemplated that in other embodiments, the frame 102 could have three or more frame members connected to one another. In some embodiments, the frame 102 could have frame members movable relative to one another.

The upper frame member 120 extends partially laterally so as to define a recess 126. The recess 126 is sized and shaped to receive at least part of the drive wheel assembly 104 therein. The upper frame member 120 further defines an aperture 128 that extends in the lateral direction. The aperture 128 is a through aperture, and is positioned at a longitudinal center of the upper frame member 120. As will also be described below, the aperture 128 is configured to receive part of the drive wheel assembly 104 therein. A cap 129 is disposed at a laterally outer end of the aperture 128 for preventing entry of debris, such as water or dust, into the aperture 128.

The lower frame member 122, which extends generally longitudinally, has an arcuate section 130 (shown in FIG. 3), which is for accommodating part of the drive wheel assembly 104.

The front and rear idler wheel assemblies 106 are connected to the front and rear ends of the lower frame member 122, respectively, and the support wheel assemblies 108 are connected to the lower frame member 122 longitudinally between the front and rear idler wheel assemblies 106. Each one of the idler and support wheel assemblies 106, 108 includes two laterally spaced wheels that are interconnected to one another by an axle. The wheels of the idler wheel assemblies 106 are larger than the wheels of the support wheel assemblies, but it is contemplated that this may vary from one embodiment to another. Each one of the idler and support wheel assemblies 106, 108 is connected to the lower frame member 122 by having the axle received in an aperture defined in the lower frame member 122. It is contemplated that the number of idler and support wheel assemblies 106, 108 may vary from one embodiment to another.

The track system 100 also includes the endless track 110, which extends around components of the track system 100, notably the frame 102, the drive wheel assembly 104, the front and rear idler wheel assemblies 106, and the support wheel assemblies 108. The endless track 110 has an inner surface 112 and an outer surface 114. The inner surface 112 of endless track 110 has a set of lugs 116 (schematically shown in FIG. 1).

The set of lugs 116 is laterally centered across a width of the endless track 110, and is adapted to engage with the drive wheel assembly 104. It is contemplated that in some embodiments, there could be two laterally spaced sets of lugs 116.

The outer surface 114 of the endless track 110 has a tread (not shown) defined thereon. It is contemplated that the tread could vary from one embodiment to another. In some embodiments, the tread could depend on the type of vehicle on which the track system 100 is to be used and/or the type of ground surface on which the vehicle is destined to travel. In the present embodiment, the endless track 110 is an endless polymeric track. It is contemplated that in some embodiments, the endless track 110 could be constructed of a wide variety of materials and structures.

Referring to FIGS. 3 and 4, the drive wheel assembly 104 includes a flange 150, a drive wheel 152 and an extension 154.

The flange 150 has a circular flange portion 160. The circular flange portion 160 defines a plurality of flange apertures 162. The flange apertures 162 are circumferentially distributed about the flange 150. As will be described below, the flange apertures 162 are configured to receive fasteners 200 therein for connecting the drive wheel 152, the extension 154 as well as a driving hub of the vehicle to one another. The flange 150 further has, on a laterally outer side thereof, an axially extending portion 164. The axially extending portion 164 extends axially from the circular flange portion 160 (in a direction away from the vehicle). The flange 150 is configured to be drivingly connected to a driving shaft of a vehicle. In some embodiments, the flange 150 is configured to be drivingly connected to a driving hub 99 (shown schematically in FIG. 4) of the vehicle, where the driving hub 99 is generally disposed at a lateral end of the driving shaft.

The drive wheel 152 has a hub portion 170 and a toothed portion 171 that extends radially outwardly from the hub portion 170.

The hub portion 170 defines a central aperture 174 configured to receive part of the flange 150 therethrough. The hub portion 170 further defines a plurality of drive wheel apertures 172. The drive wheel apertures 172 are circumferentially spaced from one another, with each drive wheel aperture 172 being aligned with a corresponding flange aperture 162. As will be described below, the drive wheel apertures are configured to receive the fasteners 200 therein.

The toothed portion 171 extends radially from the hub portion 170, and has a plurality of teeth 180. The teeth 180 are circumferentially spaced from one another. Additionally, in the present embodiment, each tooth 180 extends axially and radially. It is contemplated that in some embodiments, the configuration of the tooth 180 may vary (e.g., the tooth 180 may only extend radially). The toothed portion 171 further defines a plurality of recesses 182. Each recess 182 is in part defined by two adjacent teeth 180. The recesses 182 are configured to receive part of the lugs 116 therein.

The extension 154 has an annular connecting portion 190, a conical portion 194 extending axially from the annular connecting portion 190 and a shaft portion 196 extending axially from the conical portion 194.

The annular connecting portion 190 is configured and shaped to rest generally flat against the laterally outer side of the hub portion 170 of the drive wheel 152. The annular connecting portion 190 defines a plurality of extension apertures 192. The extension apertures 192 are circumferentially spaced from one another, with each extension aperture 192 being aligned with a corresponding drive wheel aperture 172 and a corresponding flange aperture 162. As will be described below, the extension apertures 192 are configured to receive the fasteners 200 therein.

The conical portion 194 defines a recess 195 (shown in FIG. 3). The recess 195 is sized to receive part of the axially extending portion 164. In some embodiments, the conical portion 194 and/or the recess 195 could be omitted.

The shaft portion 196 extends axially (away from the vehicle and toward and into the upper frame member 120), and is sized and shaped to be received in the aperture 128. In the present embodiment, the shaft portion 196 is press-fitted into bearings 198. The bearings 198 are themselves press-fitted into the aperture 128. Thus, the drive wheel assembly 104 can rotate relative to the frame 102. It is contemplated that the connection of the shaft portion 196 to the frame 102 could vary from one embodiment to another.

Still referring to FIGS. 3 and 4, the drive wheel assembly 104 as it is when fully assembled will now be described.

The laterally inner side of the drive wheel 152 engages the laterally outer side of the flange 150, and the laterally outer side of the drive wheel 152 engages the laterally inner side of the extension 154, such that the drive wheel 152 is sandwiched between the flange 150 and the extension 154. Thus, the flange 150 is generally disposed laterally between the vehicle and the drive wheel 152, and the extension 154 is generally disposed laterally between the drive wheel 152 and the upper frame member 120. Part of the flange 150 is received in the central aperture 174 of the drive wheel 152, and in the recess 195 of the conical portion 194. More specifically, the axially extending portion 164 extends in the central aperture 174 and in the recess 195.

The flange 150 is disposed closer to the vehicle than the hub portion 170 of the drive wheel 152 and than the extension 154, the drive wheel 152 is disposed intermediate to the flange 150 and the extension 154 and the extension 154 is closer to the frame 102 than the flange 150 and than the hub portion 170 of the drive wheel 152.

Additionally, the flange 150, the drive wheel 152 and the extension 154 are positioned, relative to one another, such that the flange apertures 162, the drive wheel apertures 172 and the extension apertures 192 are in operational alignment with one another. Fasteners 200 are received through the flange apertures 162, drive wheel apertures 172 and extension apertures 192, and through the driving hub 99 (shown schematically in FIG. 4) of the vehicle. In the present embodiment, the fasteners 200 are bolts which provide a selective connection, but other types of fasteners are contemplated.

The drive wheel assembly 104 facilitates and simplifies connection thereof to the vehicle. Specifically, the flange 150 can first be connected to the driving hub 99, the drive wheel 152 can then be connected to the flange 150 (and thus to the driving hub 99), and then the extension 154 can be connected to the drive wheel 152 (and thus to the flange 150 and to the driving hub 99). Once the drive wheel assembly 104 is connected, the upper frame member 120 can be connected thereto.

The present technology also enables the use of smaller initial castings, which can reduce manufacturing costs and material, thereby saving costs.

Modifications and improvements to the above-described embodiments of the present invention may become apparent to those skilled in the art. The foregoing description is intended to be exemplary rather than limiting.

What is claimed is:

1. A drive wheel assembly for a track system, the drive wheel assembly comprising:
a flange configured to be drivingly connected to a hub of a vehicle, the flange defining a plurality of flange apertures;
a drive wheel engaged to the flange, the drive wheel defining a plurality of drive wheel apertures;
an extension engaged to the drive wheel, the extension comprising:
a connecting portion defining a plurality of extension apertures; and
a shaft portion extending axially from the connecting portion, the shaft portion being configured to be supported by a frame of the track system; and
a plurality of fasteners for fastening the flange, the drive wheel and the extension to one another, each one of the plurality of fasteners extending through a flange aperture of the plurality of flange apertures, a drive wheel aperture of the plurality of drive wheel apertures, and an extension aperture of the plurality of extension apertures.

2. The drive wheel assembly of claim 1, wherein the drive wheel is sandwiched between the flange and the extension.

3. The drive wheel assembly of claim 1, wherein:
the connecting portion defines a recess;
the drive wheel defines an aperture; and
part of the flange is received through the recess and through the aperture.

4. The drive wheel assembly of claim 1, wherein the drive wheel has a plurality of teeth, the plurality of teeth extending in an axial direction.

5. A track system comprising:
a frame;
at least one support wheel assembly rotationally connected to the frame;
the drive wheel assembly of claim 1 rotationally connected to the frame; and
an endless track surrounding the frame, the at least one support wheel assembly and the drive wheel assembly.

6. The track system of claim 5, wherein the drive wheel assembly is configured to be disposed laterally between the frame and the vehicle.

7. The track system of claim 6, wherein the frame defines an aperture, the shaft portion of the extension is received in the aperture, and a bearing is disposed between the shaft portion and the frame.

8. The track system of claim 7, wherein the frame further includes a cap for enclosing one side of the aperture.
